(19) United States
(12) Patent Application Publication
(10) Pub. No.: US 2026/0257940 A1
(43) Pub. Date: Sep. 3, 2026

(54) WATER TREATMENT APPARATUS

(71) Applicant: LG ELECTRONICS INC., Seoul (KR)

(72) Inventors: Yuseung CHOI, Seoul (KR); Jongpil KIM, Seoul (KR); Jinhyun LEE, Seoul (KR); Sangduck LEE, Seoul (KR); Suhye WOO, Seoul (KR)

(21) Appl. No.: 18/867,517

(22) PCT Filed: May 30, 2022
(86) PCT No.: PCT/KR2022/007634

§ 371 Date: Nov. 20, 2024

(30) Foreign Application Priority Data
May 23, 2022 (KR) 10-2022-0062774

(51) Int. Cl. C02F 1/00; C02F 1/42

(52) U.S. Cl. CPC C02F 1/001; C02F 1/42; C02F 2001/422; C02F 2001/425; C02F 2201/005; C02F 2307/12

(57) ABSTRACT

A water treatment apparatus, according to the present invention, comprises: a water supply channel through which water flows from a water supply source; a main filter disposed in the water supply channel and purifying raw water into purified water; a water purification channel through which the purified water that has passed through the main filter flows; an ice-making channel branching from the water purification channel; an ice-maker mounted at an end of the ice-making channel; and a hardness reduction filter which is disposed in the ice-making channel and contains an ion exchange resin, so as to adsorb ions of introduced water, remove the ions from the water, and discharge the water.

### CROSS-REFERENCE TO RELATED PATENT APPLICATIONS

This application is a U.S. National Stage Application under 35 U.S.C. § 371 of PCT Application No. PCT/KR2022/007634, filed May 30, 2022, which claims priority to Korean Patent Application No. 10-2022-0062774, filed May 23, 2022, whose entire disclosures are hereby incorporated by reference.

### TECHNICAL FIELD

The present invention relates to a water treatment apparatus having an ice-making function.

### BACKGROUND ART

In general, water treatment apparatuses such as a water purifier, a refrigerator, etc., are apparatuses that filter water supplied from a water supply source by using physical and chemical methods to remove impurities and then supply the purified water.

Water treatment apparatuses may be classified into natural filtration-type water treatment apparatuses, direct filtration-type water treatment apparatuses, ion exchange resin-type water treatment apparatuses, distillation-type water treatment apparatuses, reverse osmotic pressure-type water treatment apparatuses, and the like according to purification principles or manners.

In addition, water treatment apparatuses are being used for household purposes as mechanisms that filter water to remove impurities.

In case of household water treatment apparatuses, the water treatment apparatuses are connected to a water supply system to remove floating matters or harmful components, which are contained in tap water and purify as much water as desired by user's manipulation to dispense the purified water.

Such a water treatment apparatus is being released as various products that are capable of dispensing hot water and cold water and are have an ice-making function to dispense ice. In addition, in recent years, water treatment apparatuses capable of being installed in various installation environments with small sizes are being developed.

In general, a refrigerator discharges cold air generated by a refrigeration cycle constituted by a compressor, a condenser, an expansion valve, and an evaporator to reduce a temperature inside the refrigerator, thereby freezing or refrigerating food and other items. In addition, the refrigerator is provided with an ice-maker to make ice and provide the made ice to a user.

In the related art, ice-making water supplied for the ice-making uses purified water filtered through a filter, and the same filter is used both when dispensing the purified water to the user and when producing the ice. If ice is made using the same filter as the filter for dispensing the purified water, there is a problem in that a TDS (total dissolved solids) concentration of the purified water passing through the filter is high, making it difficult to increase in transparency of the produced ice.

To solve this problem, existing ice purifiers or ice refrigerators make ice using water purified through a reverse osmosis (RO) membrane filter to produce clear and scale-free ice.

Since the reverse osmosis membrane filter even ionic substances in water, cations such as calcium (Ca²⁺) and magnesium (Mg²⁺) that is capable of generating scale are removed in advance, and ice is made using the produced water, and thus, the scales are not generated.

However, when using the reverse osmosis membrane filter, concentrated water (waste water) is generated, a separate drain line is required, and there is restriction depending on installation in a system such as an ice water purifier, ice refrigerator, etc., that are complex products. Thus, a filter system configuration that does not cause a water loss and does not generate the scales is required to make the ice.

In addition, the reverse osmosis (RO) filter remove heavy metals, bacteria, viruses, and minerals, but has a small water treatment capacity, and thus, a time that takes to dispense the purified water or ice is long. As a result, there is a disadvantage of requiring a separate water purification tank.

### DISCLOSURE OF THE INVENTION

### Technical Problem

An object of the present invention is to solve the above conventional problem and to provide a water treatment apparatus capable of preventing scales from being generated to improve transparency of ice.

In addition, an object of the present invention is to provide a water treatment apparatus in which raw water introduced from the outside passes through only a main filter in a situation of dispensing drinking water such as purified water, hot water, and cold water, and the introduced raw water sequentially passes through the main filter and a hardness reduction filter to secure treatment capacity of the drinking water in a situation of supplying water to an ice-maker for making ice.

In addition, an object of the present invention is to provide a water treatment apparatus in which, since a separate draining channel for discharging condensed water is unnecessary, and a purified water tank for storing purified water is unnecessary, there is no restriction in installation location, and a simple structure is provided to be miniaturized.

### Technical Solution

A water treatment apparatus according to an aspect of the present invention for achieving the above object includes a water supply channel through which water is introduced from a water supply source, a main filter disposed in the water supply channel to purify raw water into purified water, a water purification channel through which the purified water passing through the main filter flows, an ice-making channel branched from the water purification channel, an ice-maker installed on an end of the ice-making channel, and a hardness reduction filter which is disposed in the ice-making channel and contains an ion exchange resin to adsorb ions of introduced water, thereby removing the ions from the water and discharging the water.

In addition, the hardness reduction filter may include a filter housing provided with an inlet and an outlet, a first separation prevention member and a second separation prevention member, which are disposed at upper and lower portions of the inside of the filter housing, respectively, and the ion exchange resin filled in a space between the first separation prevention member and the second separation prevention member.

In addition, the ion exchange resin may include a strongly acidic cation exchange resin.

In addition, the ion exchange resin may include an anion exchange resin.

In addition, the ion exchange resin may include a strongly acidic cation exchange resin and a strongly basic anion exchange resin.

In addition, the strongly acidic cation exchange resin and the strongly basic anion exchange resin may be filled at a 1:1 ratio.

In addition, the filter housing may be constituted by an outer cover and an inner cover disposed inside the outer cover, and a hollow tube-shaped drain tube extending vertically and having opened upper and lower sides may be disposed inside the inner cover.

In addition, each of the first separation prevention member and the second separation prevention member may have a through-hole at a center thereof, and each of upper and lower ends of the drain tube may pass through the first separation prevention member and the second separation prevention member while passing through the through-hole.

In addition, a fine dust filter may be provided at a lower end of the drain tube so that water in a lower space of the filter housing passes through the fine dust filter and is introduced into a lower end of the drain tube.

In addition, an upper end of the drain tube may be connected to the outlet.

In addition, the inner cover may have a hollow tube shape, and a plurality of holes may be defined in each of upper and lower ends of the inner cover.

In addition, the outer cover may include an upper cover which is provided with an inlet and an outlet at an upper end thereof and has an opened lower side, and a lower cover configured to cover the opened lower side of the upper cover.

In addition, each of the first separation prevention member and the second separation prevention member may be made of a non-woven material.

In addition, a water purification valve configured to switch a water flow may be installed at a branch point of each of the water purification channel and the ice-making channel, and the water purification valve may operate to allow the water to flow into the water purification channel in a drinking water dispensing mode and to allow the water in the water purification channel to flow into the ice-making channel in an ice-making mode.

In addition, the main filter may include a pre-carbon block filter, an ultra filtration (UF) membrane filter, and a post-carbon block filter.

### Advantageous Effects

According to the present invention as described above, there may be the effect of preventing scales from being generated to improve the transparency of the ice.

In addition, the raw water introduced from the outside may pass through only the main filter in the situation of dispensing the drinking water such as the purified water, the hot water, and the cold water, and the introduced raw water may sequentially passes through the main filter and the hardness reduction filter to secure the treatment capacity of the drinking water in the situation of supplying the water to the ice-maker for making the ice.

In addition, since the separate draining channel for discharging the condensed water is unnecessary, and the purified water tank for storing the purified water is unnecessary, there may be no restriction in installation location, and the simple structure may be provided to be miniaturized.

### BRIEF DESCRIPTION OF THE DRAWINGS

FIG. 1 is a perspective view of a water treatment apparatus according to an embodiment of the present invention.

FIG. 2 is a schematic view illustrating an arrangement of a channel through which water flows in the water treatment apparatus according to an embodiment of the present invention.

FIG. 3 is a view illustrating a water tube diagram in the water treatment apparatus according to an embodiment of the present invention.

FIG. 4 is a view water a tube diagram in a water treatment apparatus according to another embodiment of the present invention.

FIG. 5 is a cross-sectional view of a hardness reduction filter according to an embodiment of the present invention.

FIGS. 6 and 7 are views illustrating a mechanism for removing a hardness material in the hardness reduction filter of FIG. 5.

FIG. 8 is a cross-sectional view of a hardness reduction filter according to another embodiment of the present invention.

FIG. 9 is a view illustrating a mechanism for removing a hardness material in the hardness reduction filter of FIG. 5.

FIG. 10 is a cross-sectional view of a hardness reduction filter according to further another embodiment of the present invention.

FIGS. 11 and 12 are exploded perspective views of a hardness reduction filter according to further another embodiment of the present invention.

### MODE FOR CARRYING OUT THE INVENTION

Hereinafter, some embodiments of the present disclosure will be described in detail with reference to the accompanying drawings. It is noted that the same or similar components in the drawings are designated by the same reference numerals as far as possible even if they are illustrated in different drawings. In addition, in describing embodiments of the present disclosure, if detailed descriptions of related known configurations or functions are determined to impede understanding of the embodiments of the present disclosure, the detailed descriptions will be omitted.

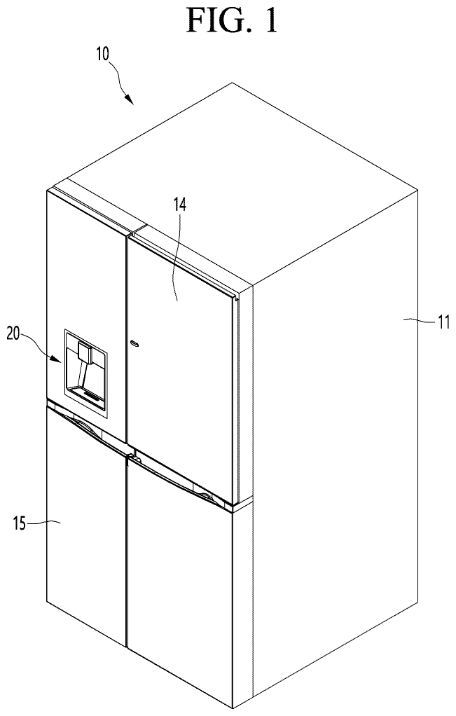

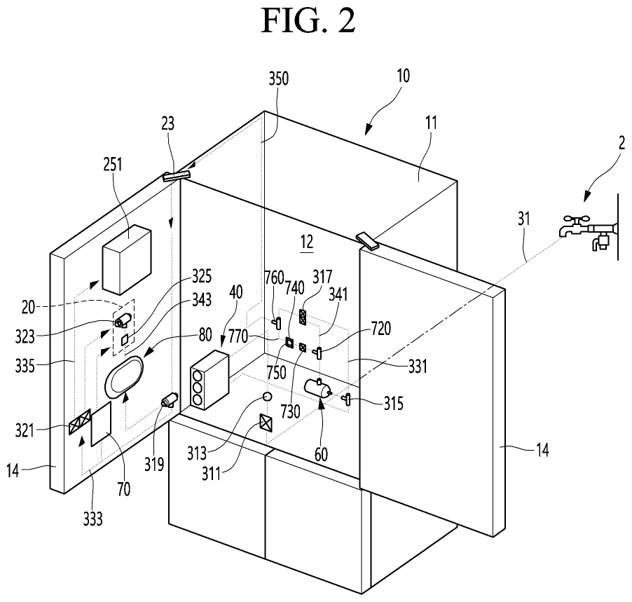

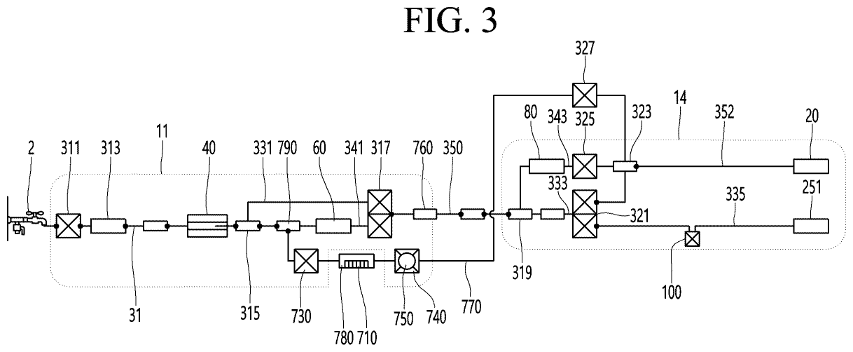

FIG. 1 is a perspective view of a water treatment apparatus according to an embodiment of the present invention, FIG. 2 is a schematic view illustrating an arrangement of a channel through which water flows in the water treatment apparatus according to an embodiment of the present invention, and FIG. 3 is a view illustrating a water tube diagram in the water treatment apparatus according to an embodiment of the present invention.

Referring to FIGS. 1 to 3, a water treatment apparatus 10 according to an embodiment of the present invention may be provided as a refrigerator that provides purified water and ice.

In following descriptions, the water treatment apparatus that is a subject of the present invention is described as a refrigerator 10, but the scope of the present invention is not limited thereto, and the water treatment apparatus according to the present invention may be a water purifier, etc.

The refrigerator 10 may include a cabinet 11 providing a storage space and doors 14 and 15 that open and close the storage space of the cabinet 11.

The storage space may include a refrigerating compartment 12 and a freezing compartment (not shown). The doors 14 and 15 may include a refrigerating compartment door 14 for opening and closing the refrigerating compartment 12 and a freezing compartment door 15 for opening and closing the freezing compartment.

The refrigerating compartment door 14 and the freezing compartment door 15 may have structures that are capable of respectively opening and closing the refrigerating compartment 12 and the freezing compartment 15 through their rotation. For this, all the refrigerating compartment door 14 and the freezing compartment door 15 may be rotatably connected to the cabinet 11 through a hinge device 23. Also, the refrigerating compartment door 14 may be a French type door in which a pair of doors disposed on both left and right sides independently rotates.

A dispenser 20 and an ice-maker may be provided in the refrigerating compartment door disposed on one side of the pair of refrigerating compartment doors 14.

The dispenser 20 may be disposed on a front surface of the refrigerating compartment door 14 to dispense at least one of water and ice cubes through user's manipulation at the outside. In addition, an ice-making chamber may be provided above the dispenser 20, and the ice-maker 251 may be accommodated inside the ice-making chamber and be opened and closed by a separate door. In addition, although not shown, the ice-making chamber may communicate with the freezing compartment by a cooling air duct to receive cool air that is required for making ice cubes from a freezing compartment evaporator (not shown) in a state in which the refrigerating compartment door 14 is closed.

The refrigerator 10 may purify water supplied from an external water supply source 2 to dispense the water that is in a purified state from the dispenser 20.

In addition, the refrigerator 10 may allow the purified water to be dispensed from the dispenser 20 in a cold or hot water state after cooling or heating the purified water.

In addition, the refrigerator may freeze the purified water so that the purified water is dispensed from the dispenser 20 in the form of ice.

The refrigerator 10 may be connected to the water supply source 2 by a water supply channel 31.

The refrigerator 10 may further include a water supply valve 311 and a water supply flow rate sensor 313, which are provided in the water supply channel 31. The supply of the raw water from the water supply source 2 may be adjusted by the opening and closing of the water supply valve 311.

The water supply flow rate sensor 313 may measure a flow rate of the water supplied from the water supply source 2. In addition, if necessary, the water supply flow rate sensor 313 may be integrated with the water supply valve 311. The water supply valve 311 may be provided in a rear surface of the cabinet 11 or a machine room in which a compressor is provided.

Alternatively, the water supply flow rate sensor 313 may measure a flow rate of cool water or purified water, which is being dispensed.

The refrigerator 10 may further include a main filter 40 for purifying the water supplied from the water supply source 2. The main filter 40 may include a plurality of filters for purifying the supplied water.

For example, the plurality of filters may be disposed to be vertically stacked within the refrigerating compartment 12. As the plurality of filters are vertically stacked, a space of the refrigerating compartment 12 may be efficiently utilized. In addition, even though water leakage occurs in the main filter 40, since only a narrow area within the refrigerating compartment 12 is contaminated, an efficient and safety space may be realized.

According to an embodiment, three filters may be provided as an example. For example, the plurality of filters may include a pre-carbon block filter, a post-carbon block filter, and an UF membrane filter disposed between the pre-carbon block filter and the post-carbon block filter.

Although the number and kind of filters are not limited, the number of filters may be provided to be accommodated in the main filter 40, and various kinds of functional filters different from each other may be applied to efficiently purify the water.

The refrigerator 10 may further include a first branch part 315 disposed at an outlet-side of the main filter 40, a body cooling water channel 341 connected to the first branch part 315, and a body water purifying channel 331 connected to the first branch part 315.

Thus, water discharged from the main filter 40 may flow to be divided into the body cold water channel 341 and the body water purification channel 331 by the first branch part 315.

A body water tank 60 may be provided in the body cold water channel 341. For example, the body water tank 60 may have a cylindrical shape and be disposed in the refrigerating compartment 12.

The refrigerator 10 may further include a body valve 317 through which the body cold channel 341 and the body water purification channel 331 are connected to each other and a common channel 350 connected to an outlet-side of the body valve 317.

For example, the body valve 317 may include two inlets and one outlet. The body water purification channel 331 and the body cold water channel 341 may be respectively connected to the two inlets, and the common channel 350 may be connected to the one outlet.

The common channel 350 may extend along the outside of the cabinet 11 after being led out from an inner case defining the refrigerating compartment 12 and then pass through the hinge device 23 of the refrigerating compartment door 14 and be led in the refrigerating compartment door 14.

The refrigerator 10 may further include a second branch part 319 connected to the common channel 350 that is led in the refrigerating compartment door 14, a door water purification channel 333 connected to the second branch part 319, and a door cold water channel 343 connected to the second branch part 319.

The refrigerator 10 may further include a door water tank 80 provided in the door cold water channel 343 and a cold water valve disposed at an outlet-side of the door water tank 80 in the door cold water channel 343.

The door water tank 80 may cool water, which is cooled in the body water tank 60 and then supplied, again. While the water cooled in the body water tank 60 flows along the common channel 350, when the water flows via the outside of the cabinet 11, the water may increase in temperature. Thus, the door water tank 80 may cool the water, which increases in temperature, again to dispense the water at a target cold water temperature when the cold water is dispensed.

Particularly, if a temperature of the water being dispensed is unsatisfactory because a temperature of water remaining in a common channel 350 outside the refrigerator 12 for a long time rises when the cold water is dispensed first after a long period of time, the temperature of the water being dispensed may not be satisfactory. However, when the cold water is dispensed, the adequate temperature of the cold water may be satisfied through the additional cooling of the water and the mixing with the cooled water in the door water tank 80.

The refrigerator 10 may further include a water purification valve 321 provided in the door water purification channel 333 and a made-ice channel 335 connected to the water purification valve 321.

The purified water flowing along the door water purification channel 333 may be dispensed to the outside of the dispenser 20 by the water purification valve or be supplied to the ice-maker 251 along the ice-making channel 335.

The refrigerator 10 may further include a door connector 323 through which the door water purification channel 333 and the door cold water channel 343 are connected to each other and a dispensing channel 352 connected to the door connector 323. The cold water and the purified water may be dispensed to the outside of the dispenser 20 along the dispensing channel 352.

The door connector 323 may include two inlets and one outlet. The door water purification channel 333 and the door cold water channel 343 may be respectively connected to the two inlets, and the dispensing channel 352 may be connected to the one outlet.

The water purification valve 321 may be a three-way valve that controls a flow direction of the purified water. Thus, to dispense the cold water, the cold water valve 325 may be opened in a state in which the water purification valve 321 is closed. On the other hand, to dispense the purified water, the water purification valve 321 may be opened in a state in which the cold water valve 325 is closed, and also, the water purification valve 321 may be switched to allow the purified water flows to the dispensing channel 352.

According to the present invention, the refrigerator 10 may include a hot water channel 770 that guides the purified water filtered by the main filter 40 to the dispenser 20 by bypassing the water tank 60, a hot water valve 730 provided in the hot water channel 770, a hot water tank 780 provided on the hot water channel 770, a heater 710 that heats the water stored in the hot water tank 780, a hot water temperature sensor 750 provided on the hot water channel 770, a hot water flow rate control valve 740 provided on the hot water channel 770, and a hot water discharge valve 327 that controls a discharge of the hot water.

Thus, the hot water from the hot water tank 780 heated by the heater 710 may be supplied to the dispenser 20.

For reference, the heater 710 may have various embodiments within a range of being able to heat the water stored in the hot water tank 780.

For example, the hot water tank 780 may be made of a metal material, particularly stainless steel, and the heater 710 may heat the hot water tank 780 using an induction heating manner.

As another example, the heater 710 may be provided as a surface heating element.

In addition, in this embodiment, the hot water tank 780 may be disposed outside the storage space. That is, the hot water tank 780 may be disposed outside the refrigerator, and the water stored in the hot water tank 780 may not be cooled by cold air of the storage space and have a temperature similar to room temperature.

In this case, the water stored in the hot water tank 780 is not cooled. Thus, when generating the hot water, the water stored in the hot water tank 780 may be heated immediately without having to separately discharge the stored water. Thus, not only the water may be saved, but also, heat energy required to generate the hot water may be reduced to improve heat efficiency.

In addition, when the hot water tank 780 is disposed outside the refrigerator as described above, the heater 710 may also be disposed outside the refrigerator, and since the heat generated from the heater 710 does not affect the temperature inside the refrigerator, efficiency of the refrigerator may be improved compared to when the heater 710 is disposed inside the refrigerator.

Hereinafter, a process of generating and discharging the hot water in the refrigerator in which the hot water tank 780 is disposed outside as described above is described.

First, when a hot water discharge command is input from a door-side, the hot water valve 730 may be opened, and the water intake valve 311 may also be opened. Since the water inlet valve 311 is opened as described above, the water of the water supply source may be introduced into the water supply channel 31 and be supplied to the filter device 40.

The purified water filtered in the main filter 40 may pass sequentially through the first branch part 315 and the third branch part 790 and may be transferred to the hot water channel 770. The purified water transferred to the hot water channel 770 may pass through the hot water valve 730 and then be stored in the hot water tank 780.

Here, when the heater 710 operates, the purified water stored in the hot water tank 780 may be heated into hot water, and the heated hot water may be dispensed through the hot water discharge valve 327, the door connector 323, and the dispensing channel 352 to the dispenser 20.

In the related art, ice-making water supplied for the ice-making uses purified water filtered through a filter, and the same filter is used both when dispensing the purified water to the user and when producing the ice. If ice is made using the same filter as the filter for dispensing the purified water, there is a problem in that a TDS (total dissolved solids) concentration of the purified water passing through the filter is high, making it difficult to increase in transparency of the produced ice.

To solve this problem, the present invention additionally includes a hardness reduction filter 100 that removes a hardness material contained in water.

In detail, the hardness reduction filter 100 may be installed in one of the channels connecting the main filter 40 to the ice-maker 251.

That is, in the case of drinking water, a channel may be configured to pass only through the main filter 40, and in the case of purified water flowing to the ice-maker 251 for making ice, a channel may be configured to pass sequentially through the main filter 40 and the hardness reduction filter 100.

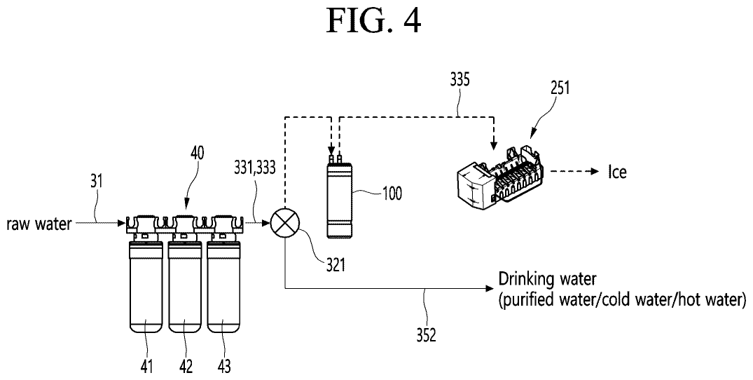

FIG. 4 is a view water a tube diagram in a water treatment apparatus according to another embodiment of the present invention.

Referring to FIGS. 3 and 4, a hardness reduction filter 100 may be disposed between a main filter 40 and an ice-maker 251 based on a water flow path to receive purified water passing through the main filter 40, remove or reduce a hardness material, and discharge the purified water toward the ice-maker 251.

For example, the hardness reduction filter 100 may be installed in an ice-making channel 335 connecting a water purification valve 321 to the ice-maker 251.

Here, the ice-making channel 335 may be branched from a body water purification channel 331. In addition, the ice-making channel 335 may be branched from a door water purification channel 333.

As described above, when the hardness reduction filter 100 is installed in the ice-making channel 335, the purified water flowing from the water purification valve 321 to the ice-maker 251 may pass through the hardness reduction filter 100, and thus, the hardness material may be removed, and the purified water may be supplied to the ice-maker 251 with reduced hardness.

In addition, when ice is made in the ice-maker 251, scales are not generated on the ice due to the hardness material, and thus, transparent ice may be made.

The hardness reduction filter 100 may have various embodiments within a range of being able to remove a hardness generation material from the received water.

For example, the hardness reduction filter 100 may have a built-in ion exchange resin, adsorb ions from the introduced water, remove the ions in the water, and discharge the water from which the ions are removed.

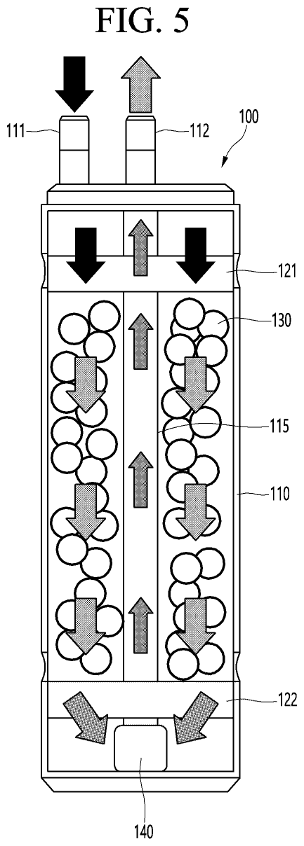

FIG. 5 is a cross-sectional view of the hardness reduction filter according to an embodiment of the present invention.

Referring to FIG. 5, the hardness reduction filter 100 may include a filter housing 110 having an inlet 111 and an outlet 112, a first separation prevention member 121 and a second separation prevention member 122, which are respectively disposed at upper and lower portions of the filter housing 110, and an ion exchange resin 130 disposed in a space between the first separation prevention member 121 and the second separation prevention member 122.

The ion exchange resin 130 may be accommodated inside the filter housing 110 in various forms

Thus, the purified water introduced through the inlet 111 may undergo ion exchange in the ion exchange resin 130 while passing between the first separation prevention member 121 and the second separation prevention member 122, and thus, the hardness generation material may be removed. In addition, the purified water from which the hardness generation material have been removed may be discharged to the outside of the filter housing 110 through the outlet 112 and then flow to the ice-maker 251.

Each of the first separation prevention member 121 and the second separation prevention member 122 may be made of a water-permeable material. In addition, each of the first separation prevention member 121 and the second separation prevention member 122 may be made of a non-woven fabric material.

Each of the first separation prevention member 121 and the second separation prevention member 122 may be made of a non-woven fabric material having a thickness of 5 μm to 10 μm.

Thus, the ion exchange resin 130 may be filled between the first separation prevention member 121 and the second separation prevention member 122. In addition, as the water passes through the first separation prevention member 121 and the second separation prevention member 122, various foreign substances may be additionally filtered.

The first separation prevention member 121 and the second separation prevention member 122 may serve to fix the ion exchange resin 130 so as not to be separated. That is, upper and lower portions of the ion exchange resin 130 may be blocked by the first separation prevention member 121 and the second separation prevention member 122 and thus may not be separated through the upper and lower portions, and the filled state of the ion exchange resin 130 between the first separation prevention member 121 and the second separation prevention member 122 may be maintained.

In addition, the first separation prevention member 121 and the second separation prevention member 122 may filter water introduced into the ion exchange resin 130 and additionally filter water passing through the ion exchange resin 130.

As described above, when the first separation prevention member 121 and the second separation prevention member 122 are respectively disposed above and below the ion exchange resin 130, the separation of the ion exchange resin 130 may be prevented, and simultaneously, filtration power may be added to improve water purification efficiency.

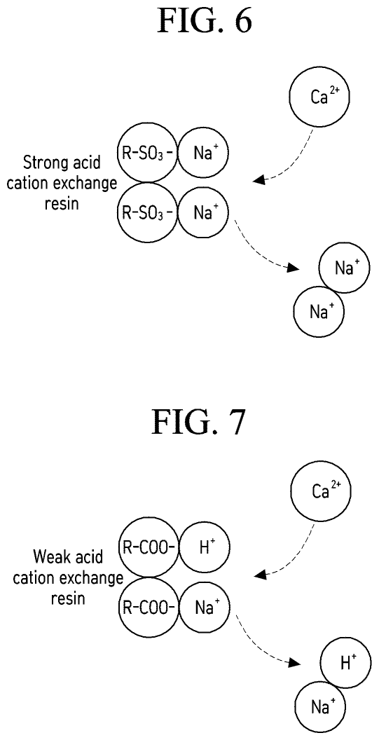

FIGS. 6 and 7 are views illustrating a mechanism for removing the hardness material in the hardness reduction filter of FIG. 5.

For example, the ion exchange resin 130 may be provided as a strongly acidic cation exchange resin.

For reference, during an ice-making process, cations (Ca²⁺ and Mg²⁺) in water generate scales (CaCO₃, CaSO₄, and MgCO₃) according to Chemical Formulas 1 to 3 below.

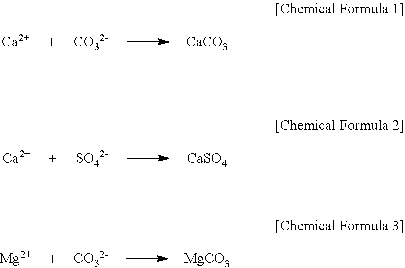

FIG. 6 is a view illustrating a mechanism for removing the hardness material in a situation in which the ion exchange resin 130 is provided as the strongly acidic cation exchange resin.

Referring to FIG. 6, the strongly acidic cation exchange resin may adsorb and remove the hardness generation material (Ca²⁺) from the water through Chemical Formula 4 below. In addition, since a scale generation material is adsorbed and removed, scales may not be generated during the ice-making process, and thus, transparent ice may be made.

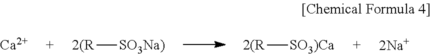

Here, selectivity of the above-mentioned strongly acidic cation exchange resin may be compared as follows.

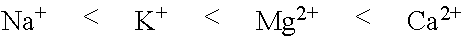 [SMILES: [Mg+2] ; [Ca+2] ; [Na+] ; [K+]]

As another example, the ion exchange resin 130 may be provided as a weakly acidic cation exchange resin.

Referring to FIG. 7, the weakly acidic cation exchange resin may adsorb and remove the hardness generation material (Ca²⁺) from the water through Chemical Formula 5 below. In addition, since a scale generation material is adsorbed and removed, scales may not be generated during the ice-making process, and thus, transparent ice may be made.

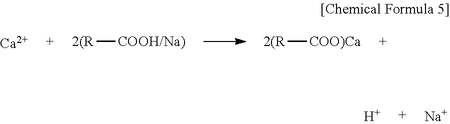

Here, selectivity of the above-mentioned weakly acidic cation exchange resin may be compared as follows.

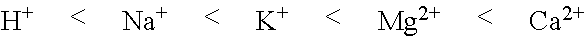

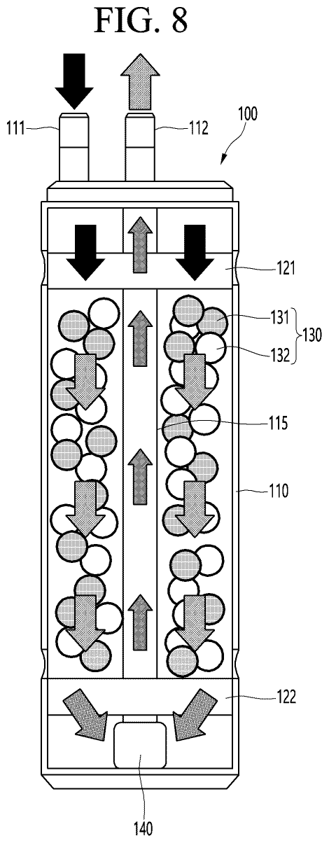

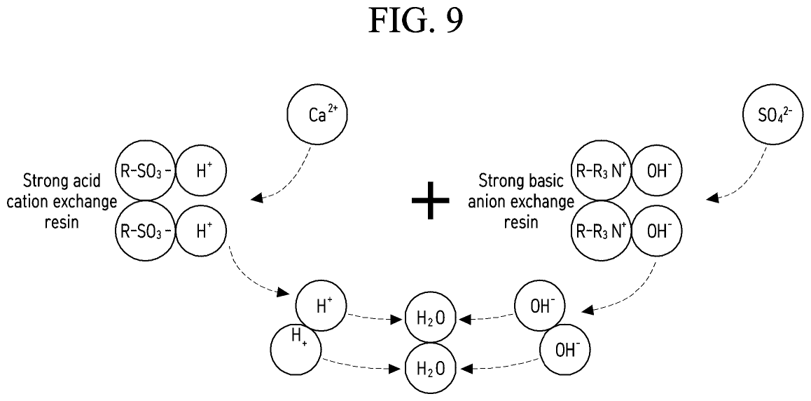

FIG. 8 is a cross-sectional view of a hardness reduction filter according to another embodiment of the present invention. In addition, FIG. 9 is a view illustrating a mechanism for removing a hardness material in the hardness reduction filter of FIG. 5.

Referring to FIGS. 8 and 9, the ion exchange resin 130 may include an anion exchange resin.

As another example, the ion exchange resin 130 may include a strongly acidic cation exchange resin 131 and a strongly basic anion exchange resin 132.

Here, selectivity of the strongly basic anion exchange resin 132 may be compared as follows.

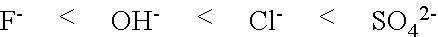

In addition, the strongly acidic cation exchange resin and the strongly basic anion exchange resin may be filled at a 1:1 ratio.

Referring to FIG. 9, when the strongly acidic cation exchange resin and the strongly basic anion exchange resin are filled at the 1:1 ratio as described above, water (H₂O) may ultimately be generated by anion (OH⁻) generated by ion exchange in the strongly basic anion exchange resin and cation (H⁺) generated by ion exchange in the strongly acidic cation exchange resin.

As described above, water from which the hardness generation material have been removed while passing through the ion exchange resin is supplied to an ice-maker 251 in a softened state.

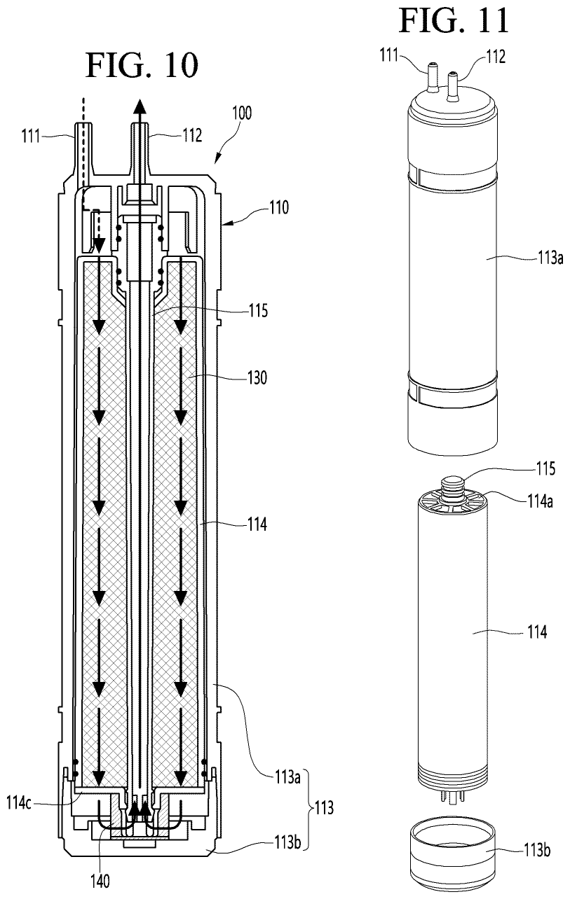

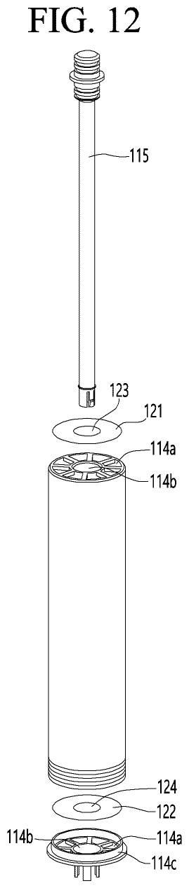

FIG. 10 is a cross-sectional view of a hardness reduction filter according to further another embodiment of the present invention. In addition, FIGS. 11 and 12 are exploded perspective views of a hardness reduction filter according to further another embodiment of the present invention.

Referring to FIGS. 10 to 12, the filter housing 110 may be constituted by an outer cover 113 and an inner cover 114 disposed inside the outer cover 113, and a hollow-shaped drain tube 115 extending in a vertical direction and having opened upper and lower sides may be disposed inside the inner cover 114.

A first separation prevention member 121 and a second separation prevention member 122 have through-holes 123 and 124 in their centers, respectively, and upper and lower ends of the drain tube 115 pass through the through-holes 123 and 124 to pass through the first separation prevention member 121 and the second separation prevention member 122.

Each of the first separation prevention member 121 and the second separation prevention member 122 may be made of a non-woven fabric material.

Here, the non-woven fabric may be configured to filter particles having a size of 5 μm to 10 μm or more.

A fine dust filter 140 is provided at the lower end of the drain tube 115, and thus, water in a lower space of the filter housing 110 passes through the fine dust filter 140 and then is introduced into the lower end of the drain tube 115.

The fine dust filter 140 may be made of a non-woven material.

Here, the non-woven fabric may be configured to filter particles having a size of 5 μm to 10 μm or more.

The fine dust filter 140 may be provided to cover the lower end of the drain tube 115.

Thus, the water that is finally discharged through the drain tube 115 may be filtered once more to filter fine substances in the water.

The upper end of the drain tube 115 is connected to the outlet 112.

Thus, water flowing upward along the drain tube 115 may be discharged to the outside of the filter housing 110 through the outlet 112.

In addition, the inner cover 114 may be provided in the shape of a hollow tube, and a plurality of water transfer holes 114a may be defined in top and bottom surfaces to allow the water to flow.

In addition, the inner cover 114 has a through-hole 114b, through which the drain tube 115 passes, in a center of each of the top and bottom surfaces.

In addition, the inner cover 114 may have an opened lower side, and the opened lower side of the inner cover 114 may be covered by a separate cover 114c. In addition, the cover 114c may have a through-hole 114b, through which the drain tube 115 passes, in a center thereof, and a plurality of water transfer hole 114a may be defined around the through-hole 114b.

In addition, the outer cover 113 may include an upper cover 113a provided with an inlet 111 and an outlet 112 at an upper end thereof and having an opened lower side, and a lower cover 113b that covers the opened lower side of the upper cover 113a.

A water purification channel 321 that switches a water flow may be installed at a branch point of the water purification channels 331 and 333 and the ice-making channel 335, and the water purification valve 321 may operate to allow water to flow into the water purification channels 331 and 333 in a drinking water dispensing mode and to allow water in the water purification channels 331 and 333 to flow into the ice-making channel 335 in an ice-making mode.

The water purification valve 321 may be provided as a three-way valve having one inlet and two outlets.

The main filter 40 may include a pre-carbon block filter 41 having ability to remove nine types of heavy metals, an ultra filtration (UF) membrane filter 42, and a post-carbon block filter 43 having virus removal performance.

According to the present invention as described above, the heavy metals may be removed and purified as introduced raw water passes through the pre-carbon block filter 41 having a first carbon block having the form of a hollow tube.

For example, the first carbon block may be manufactured by mixing activated carbon, binder, iron hydroxide, and titanium oxide, and the nine types of heavy metals may be removed when the introduced water passes through the first carbon block.

In addition, water discharged outside the pre-carbon block filter 41 passes through the UF membrane filter 42 having a plurality of built-in hollow fiber membranes and the post-carbon block filter 43 having a hollow tube-shaped second carbon block and an electrostatic adsorption nonwoven fabric that is wrapped around the second carbon block.

For example, like the first carbon block, the second carbon block may be manufactured by mixing activated carbon, binder, iron hydroxide, and titanium oxide, and the nine types of heavy metals may be removed when the introduced water passes through the second carbon block.

When the pre-carbon block filter 41, the UF membrane filter 42, and the post-carbon block filter 43 are provided as described above, the water flowing into the main filter 40 may pass through the pre-carbon block filter 41, the UF membrane filter 42, and the post-carbon block filter 43 and thus be purified multiple times to achieve an effect of more reliably removing various foreign substances including heavy metals, bacteria and viruses.

Particularly, chlorine components and chloroform (CHCl₃) in water may be removed more reliably by using the post-carbon block filter 43, and thus, taste of water may also be improved.

For reference, the nine types of heavy metals, i.e., mercury, lead, copper, aluminum, iron, cadmium, arsenic, manganese, and zinc may be removed when passing through the first or second carbon blocks in which activated carbon, binder, iron hydroxide, and titanium oxide are mixed.

In detail, mercury, lead, iron, aluminum, cadmium, arsenic, and copper may be removed by iron hydroxide within the carbon blocks 120 and 310, and manganese and zinc may be removed by titanium oxide within the carbon blocks 120 and 310.

1. A water treatment apparatus comprising:
a water supply channel through which water is introduced from a water supply source;
a main filter disposed in the water supply channel to purify raw water into purified water;
a water purification channel through which the purified water passing through the main filter flows;
an ice-making channel branched from the water purification channel;
an ice-maker installed on an end of the ice-making channel; and
a hardness reduction filter which is disposed in the ice-making channel and contains an ion exchange resin to adsorb ions of introduced water, thereby removing the ions from the water and discharging the water.

2. The water treatment apparatus according to claim 1, wherein the hardness reduction filter comprises:
a filter housing provided with an inlet and an outlet;
a first separation prevention member and a second separation prevention member, which are disposed at upper and lower portions of the inside of the filter housing, respectively; and
the ion exchange resin filled in a space between the first separation prevention member and the second separation prevention member.

3. The water treatment apparatus according to claim 2, wherein the ion exchange resin comprises a strongly acidic cation exchange resin.

4. The water treatment apparatus according to claim 2, wherein the ion exchange resin comprises a weakly acidic cation exchange resin.

5. The water treatment apparatus according to claim 2, wherein the ion exchange resin comprises an anion exchange resin.

6. The water treatment apparatus according to claim 1, wherein the ion exchange resin comprises a strongly acidic cation exchange resin and a strongly basic anion exchange resin.

7. The water treatment apparatus according to claim 6, wherein the strongly acidic cation exchange resin and the strongly basic anion exchange resin are filled at a 1:1 ratio.

8. The water treatment apparatus according to claim 2, wherein the filter housing is constituted by an outer cover and an inner cover disposed inside the outer cover, and
a hollow tube-shaped drain tube extending vertically and having opened upper and lower sides is disposed inside the inner cover.

9. The water treatment apparatus according to claim 8, wherein each of the first separation prevention member and the second separation prevention member has a through-hole at a center thereof, and
each of upper and lower ends of the drain tube passes through the first separation prevention member and the second separation prevention member while passing through the through-hole.

10. The water treatment apparatus according to claim 8, wherein a fine dust filter is provided at a lower end of the drain tube so that water in a lower space of the filter housing passes through the fine dust filter and is introduced into a lower end of the drain tube.

11. The water treatment apparatus according to claim 8, wherein an upper end of the drain tube is connected to the outlet.

12. The water treatment apparatus according to claim 8, wherein the inner cover has a hollow tube shape, and
a plurality of holes are defined in each of upper and lower ends of the inner cover.

13. The water treatment apparatus according to claim 8, wherein the outer cover comprises:
an upper cover which is provided with an inlet and an outlet at an upper end thereof and has an opened lower side; and
a lower cover configured to cover the opened lower side of the upper cover.

14. The water treatment apparatus according to claim 2, wherein each of the first separation prevention member and the second separation prevention member is made of a non-woven material.

15. The water treatment apparatus according to claim 1, wherein a water purification valve configured to switch a water flow is installed at a branch point of each of the water purification channel and the ice-making channel, and
the water purification valve operates to allow the water to flow into the water purification channel in a drinking water dispensing mode and to allow the water in the water purification channel to flow into the ice-making channel in an ice-making mode.

16. The water treatment apparatus according to claim 1, wherein the main filter comprises a pre-carbon block filter, an ultra filtration (UF) membrane filter, and a post-carbon block filter.
